(19) United States
(12) Patent Application Publication
(10) Pub. No.: US 2012/0166235 A1
(43) Pub. Date: Jun. 28, 2012

(54) SYSTEM AND METHOD FOR PROGRAMMATICALLY BENCHMARKING PERFORMANCE OF CONTACT CENTERS ON SOCIAL NETWORKS

(75) Inventor: Reinhard Klemm, Basking Ridge, NJ (US)

(73) Assignee: Avaya Inc., Basking Ridge, NJ (US)

(21) Appl. No.: 12/978,911

(22) Filed: Dec. 27, 2010

(51) Int. Cl. G06Q 10/00

(52) U.S. Cl. 705/7.11

(57) ABSTRACT

Disclosed are systems, methods, and non-transitory computer-readable storage media for benchmarking the performance of a contact center of an enterprise with respect to online communications channels. A system configured to practice the method first identifies messages posted by users on an online communications channel during a first time interval. Each of these messages includes an identification of user problems encountered by the users. The system then identifies messages posted by agents of the enterprise on the online communications channel. Specifically, the messages identified are those consisting of an agents responding to the user problems identified in messages posted by the users. The system can then generate response performance measures for the enterprise. The response performance measures can be based on a temporal relationship between corresponding messages posted by a users and agents. Alternatively, the performance measures can be based on users' response to the responses provided by the agents.

### BACKGROUND

1. Technical Field

The present disclosure relates to social networks and more specifically to systems and methods for programmatically benchmarking performance of contact centers on social.

2. Introduction

Remote customer service, provided by an enterprise contact center, can be an important competitive advantage for an enterprise. However, it is traditionally difficult to compare the performance of contact centers of competing companies, as most enterprises typically maintain contact center performance a closely guarded corporate secret. As a result, it is generally difficult to obtain accurate data about the performance of contact centers. Accordingly, an enterprise may not be able to accurately gauge the performance of its competitors and determine whether the performance of its contact center provides any competitive advantages over those of its competitors. Even worse, an enterprise may be unable to determine whether a competitor's contact center is being operated in a way that provides the competitor with a competitive advantage.

In general, analysis of competitors can be performed via a programmatic analysis of messages posted on electronic message boards by customers, such as in a social network or other online sites or networks. However, the usefulness of this type of analysis is typically limited to determining general user sentiment about an enterprise and its products, services, and reputation. As a result, such an analysis is typically of little or no use for purposes of evaluating the performance of an enterprise's customer contact center.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for benchmarking the performance of a contact center of an enterprise with respect to online communications channels. The various embodiments will be described with respect to evaluating performance of a contact center with respect to messages on one or more particular online communications channels but the concept of evaluating is applicable to other types of online communications channels as well. A system configured to practice the method first identifies messages posted by one or more users on an online communications channel during a first time interval. Each of these messages includes an identification of at least one user problem encountered by one of the users. The system then identifies a messages posted by one or more agents of the enterprise on the online communications channel. Specifically, the messages identified are those consisting of an agent responding to the user problem identified in at least one of the messages posted by the users. The system can then generate one or more response performance measures for the enterprise. The performance measures can be based on a temporal relationship between a message posted by a user and a message including a corresponding agent response. Alternatively, the performance measures can be based on users' response to the response being provided by agents of the enterprise.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary architecture in which the various embodiments can be implemented;

FIG. 3 illustrates an example method embodiment;

FIG. 4 illustrates an example method embodiment; and

FIG. 5 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

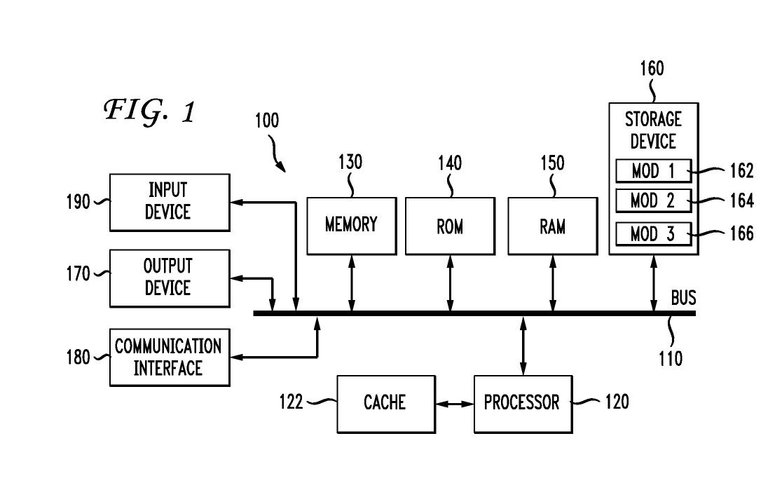

The present disclosure addresses the need in the art for evaluating the performance of a contact center of an enterprise. A system, method and non-transitory computer-readable media are disclosed which can benchmark the performance of a contact center of an enterprise. A brief introductory description of a basic general purpose system or computing device in FIG. 1 which can be employed to practice the concepts is disclosed herein. A more detailed description of an operating environment and exemplary methods will then follow.

As noted above, obtaining data regarding the performance of a customer contact center of a competitor is typically difficult to obtain. However, social networks, such as Facebook® and Twitter®, are increasingly being used by enterprises as a platform for providing remote customer service to customers. That is, customers post messages on an electronic message board of the social network to the attention of the company and contact center agents read and respond to these customer posts on the social network. Furthermore, these social network interactions are generally public. Accordingly, every participant in the social network, which can include representatives of competing companies, can have access to these interactions.

In view of the availability of such interactions, the various embodiments provide systems and methods for benchmarking customer service performance of an enterprise based on an analysis of these interactions. In particular, the various embodiments provide a system and method for deriving a variety of statistics from social network interactions between users and contact centers of competing enterprises. Theses gathered statistics can aid in benchmarking the performance of the contact centers of competing companies. These variations shall be discussed herein as the various embodiments are set forth. The disclosure now turns to FIG. 1.

With reference to FIG. 1, an exemplary system 100 includes a general-purpose computing device 100; including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules, Mod1 162, Mod2 164 and Mod3 166, which are modules configured to control the processor 120. These modules may be stored on the storage device 160 and loaded into RAM 150 or memory 130 at runtime or may be stored as would be known in the art in other computer-readable memory locations.

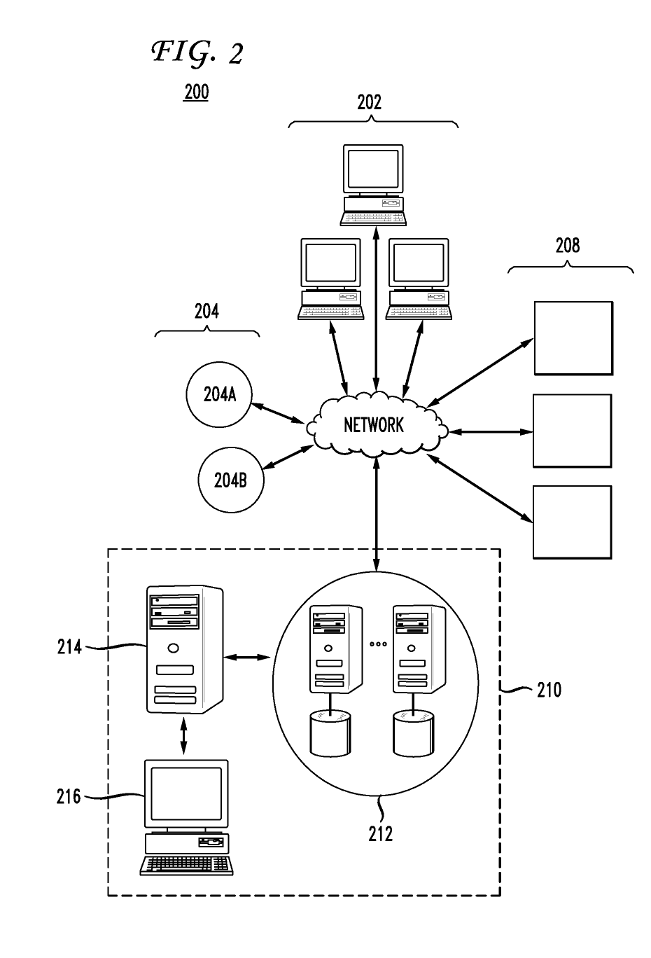

Having disclosed some components of a computing system, the disclosure now turns to FIG. 2, which illustrates an exemplary network architecture 200 for implementing one or more embodiments of the disclosure.

As shown in FIG. 2, the architecture 200 includes elements for supporting interactions between users and enterprises for purposes of providing customer care via social media. In particular, the architecture 200 includes one or more customer or user terminals 202 operated by users to access social media channels 204 via a network 206. Additionally, the architecture includes one or more enterprise contact centers 208 accessing the social media channels 204 via network 206.

As used herein, a “social media channel” refers to any type of online communications channel over which an interaction between a user and an enterprise can occur and which allows other users to monitor the interaction and participate in the interaction. Examples of such online communications channels include, but are not limited to, internet forums and electronic message boards, weblogs, social blogs, microblogs, wikis, and media sharing sites (i.e., audio, image, and/or video sharing sites). Accordingly, although the various embodiments will be described primarily with respect to exchange of text-based messages, this is solely for ease of illustration and the various embodiments are not limited in this regard.

The social media channels 204 in architecture 200 can be configured and/or managed in several ways in the various embodiments. For example, each of the social media channels 204 can be configured to operate as a direct social media channel 204A or as an indirect social media channel 204B. As used herein, a “direct” social media channel refers a social media channel that is directly related or associated with the enterprise. For example, the social media channel can be a publically accessible communications channel that is managed and controlled by the customer care center of the enterprise, such as a customer support user forum established and managed by the enterprise. However, in the various embodiments, such direct social media channels can also include online communications channels which are partially managed or controlled by the enterprise. For example, a Facebook® or Twitter® site or other internet-based portal established by the enterprise. However, the various embodiments are not limited to the examples above and a direct social media channel can include any other type of communications channel in which the content is at least partially managed or controlled by the enterprise.

In contrast, an “indirect” social media channel refers to a social media channel in which the enterprise is a participant and is not involved in the management, establishment, or control thereof. Such indirect social media channels can include channels that are viewable by the general public, including channels requiring registration or having some type of authentication procedures for accessing the channel. For example, a blog or other online communications channel established by one or more customers of the enterprise. In such a communication channel, the enterprise can monitor and interact with customers, but content in the communications channel is controlled by others. However, the various embodiments are not limited to the examples above and an indirect social media channel can include any other type of communications channel in which the enterprise does not have control of the content posted thereon.

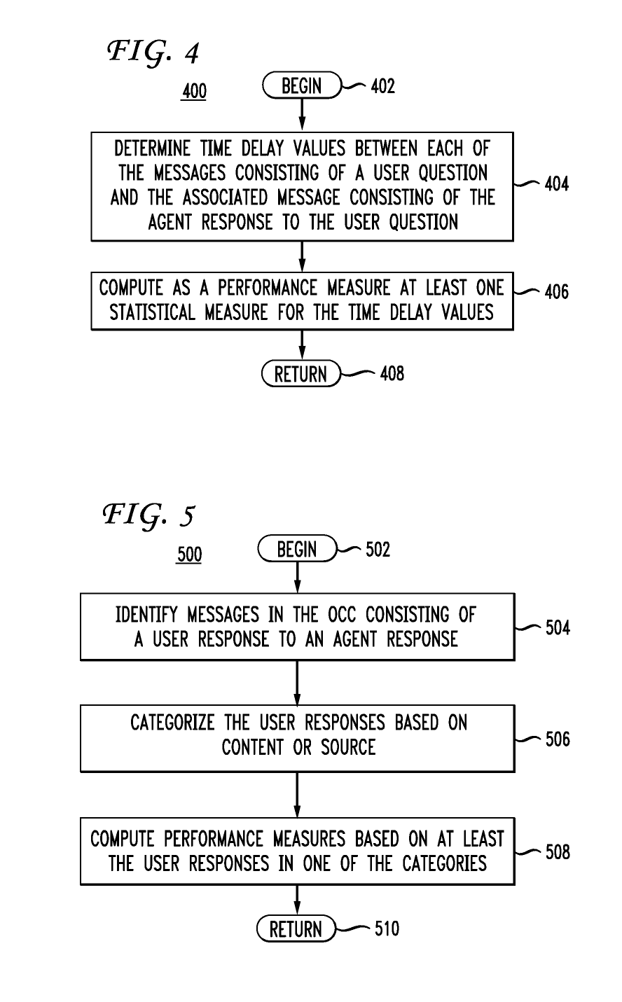

The architecture 200 additionally includes a benchmarking system 210 for collecting data from the social media channels 204 and generating performance measures associated with one or more of the enterprise contact centers 208. In particular, the benchmarking system 210 can include one or more data retrieval clients 212 for accessing the social media channels 204 and retrieving content and information related to interactions between users and an enterprise. The benchmarking system 210 can also include a data analysis module 214 for analyzing user/enterprise interactions and for generating performance measures based on the interactions. Additionally, the benchmarking system can include a user interface or terminal 216 for viewing the output of data analysis module 214. Details of the operation of benchmarking system 210 will be described in greater detail below with respect to FIGS. 4, 5, and 6.

FIG. 2 represents a single exemplary architecture in accordance with the various embodiments. However, other architectures and combinations of architectures can also be used in the various embodiments. For example, each of the elements in architecture 200 can be configured to operate as a standalone device or implemented in a distributed fashion over one or more networks. In another example, the functions of two or more elements of architecture 200 can be combined into a single component. In yet another example, different portions of benchmarking system 210 can be dedicated to retrieval and analysis of interaction data associated with a single enterprise, a selected portion of and enterprise, or any other intra-enterprise or inter-enterprise segment associated with architecture 200. For example, specific portions of benchmarking system 210 can be configured to monitor particular types of online communications channels for a single enterprise or for multiple enterprises. Similarly, specific portions of benchmarking system 210 can be configured to monitor portions of architecture 200 associated with different segments of users based on geographic information, demographic information, product information, or any other type of information describing the users. Additionally, separately or in combination with the above, specific portions of benchmarking system 210 can also be configured to monitor portions of architecture associated with different agents or groups of agents in the enterprise and can also be based on geographic information, demographic information, product information, or any other type of information describing the agents or their roles in the customer contact center of the enterprise.

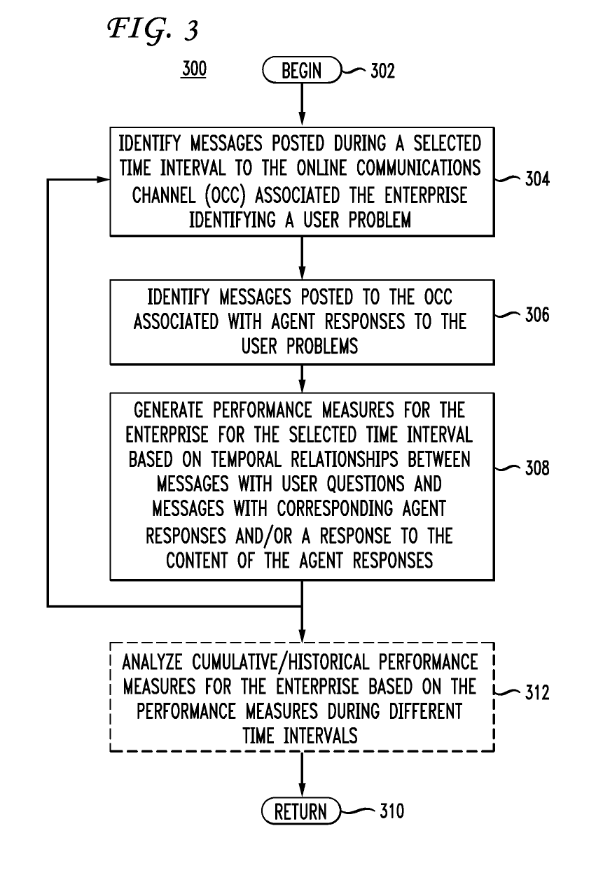

Having disclosed some basic system components and concepts, the disclosure now turns to the exemplary method embodiment shown in FIG. 3. For the sake of clarity, the method is discussed in terms of an exemplary architecture 200 as shown in FIG. 2 configured to practice the method. The steps outlined herein are exemplary and can be implemented in any combination or permutation thereof, including combinations that exclude, add, or modify certain steps.

FIG. 3 is a flowchart of steps in an exemplary method 300 for benchmarking performance of a customer care center of an enterprise. Method 300 begins at step 302 and continues at step 304.

At step 304, the benchmarking system 210 can access an online communications channel showing or logging interactions between users and agents of at least one enterprise and identify any messages posted by users during a selected time interval that includes a question targeted for the enterprise. In the various embodiments, a question for the enterprise can be provided in several forms in the online communications channel, depending on the form and type of the online communications channel. Therefore, in some embodiments, the message can include a question directed explicitly to the enterprise and/or can be identified as such. In other embodiments, the message can include a question to the community of users in general, including the enterprise, to provide an answer. In yet other embodiments, the form and content of a message may not explicitly include a question, but implies that assistance is required and/or requested. For example, an online communications channel can be configured to allow users to post a message describing or identifying observed issues with product. The enterprise can provide some response to such a message. Accordingly, the benchmarking system 210 can be configured to identify messages associated with a question for the enterprise based on the type, form, and/or context of the messages in the online communication channel being monitored.

In one aspect, an angry, anxious, or otherwise overly eager customer may post the same (or substantially the same) question or problem on multiple different social media communication channels, such as an enterprise-hosted forum, on the enterprise's Facebook customer support page, and on Twitter. The system can combine these separate postings into a single “problem” associated with the customer and associated one or more enterprise agent response with the bundle of multiple posts from that customer.

Recognition of such questions can be performed in a variety of ways. For example, keyword or symbol spotting can be used to identify user questions in some embodiments. That is, a message from a user can be analyzed to see if it includes any keywords or symbols typically associated with a question or identification of an issue or concern. In other embodiments, natural language understanding or natural language processing techniques can be used to ascertain the content of a message and determine whether or not a question is being posed.

Once the messages associated with a question are identified at step 304, at step 306 the benchmarking system 210 can identify any messages associated with a response by an agent of the enterprise to one of the messages associated with a question. In the various embodiments, a response from an agent of the enterprise can be provided in several forms in the online communications channel, depending on the form and type of the online communications channel. Therefore, in some embodiments, the message with the agent response can refer explicitly or can be associated with the question being answered. For example, in an electronic message board, the response can include the text of the question or the response can simply be part of the same message thread.

In other embodiments, the message from the user agent can be a general response. For example, in some instances, several users may pose the same question, similar questions, or different questions regarding an issue or topic. Thus, rather than provide a response for each and every user separately, the user agent may instead post information intended to respond to the several users. Accordingly, the benchmarking system 210 can also be configured to identify responses from a user agent to one or more users based on the type, form, and/or context of the response with respect to the messages associated with questions in the online communication channel being monitored.

The association between user messages and an agent response for such a general response can be identified in a variety of ways. For example, in one embodiment the response can be associated with user messages based on keywords. That is, the agent response may include keywords that are common to a group of user messages. In another example, the agent response can be analyzed to see what question the agent was answered and thereafter the user messages can be analyzed to see which user messages include a same or similar question. In such embodiments, natural language understanding or natural language processing techniques can be used to ascertain the content of the agent response and the user messages and to determine which of the user messages is related to the agent response.

Following the identification of messages associated with agent responses at step 306, the benchmarking system can generate various types of performance measures for the enterprise for the selected time interval can be generated at step 308. For example, a performance measure can be generated that indicates the temporal relationship between questions and responses. This is further described with respect to FIG. 4. In another example, a performance measure can be generated that indicates user response to agent responses. This aspect is further described with respect to FIG. 5.

Once the performance measures for the selected time interval are obtained at step 308, the performance measures can be output or stored for use and the method can end at step 310 and resume previous processing. However, in some instances it may be desirable to monitor the performance of an enterprise over time. Accordingly, in some embodiments, steps 304-308 can be repeated multiple times or continuously. Thereafter, a cumulative or historical performance for an enterprise can be analyzed at step 312, indicating the performance measures for two or more periods of time. For example, the benchmarking system, 210 can be configured to plot the performance measures generated at step 308. In another example, the performance measures generated at step 308 can be analyzed to determine the historical performance of the enterprise. In still another example, the performance measures generated at step 308 can be used to project trends of future performance of the enterprise. After step 312, the method 300 can end at step 310.

Referring now to FIG. 4, there is shown a flowchart of steps in an exemplary method 400 for generating performance measures based on a temporal relationship between user questions and agent responses. The method 400 begins at step 402 (after steps 304 and 306) and continues to step 404. At step 404, the time delay between each of the messages posing a question and an associated agent response is determined. In the various embodiments, this delay can be computed using time stamp information or other metadata associated with the messages. With respect to messages associated with a particular response, such a delay can be easily computed. However, in other cases, additional computation can be required. For example, in the case of a general response, such a response will be associated with multiple user messages. In some embodiments, these can be treated as separate sets of the user messages and agent responses and thus result in multiple time delay values. However, in other embodiments, a single time delay value can be determined. For example, in the case of a general response associated with multiple questions, the single time delay value can be computed as, for example, an average time delay, a maximum time delay, or a minimum time delay. However, the various embodiments are not limited in this regard.

Once the time delay values to be analyzed are determined at step 404, at least one statistical measure for these time delay values can be computed at step 406. In the various embodiments, any type of statistical measure can be used to characterize the time delays associated with responses from the enterprise and thus provide a measure of the overall response of the enterprise during a time period. For example, the statistical measure can be a mean, a maximum, minimum time delay. However, the various embodiments are not limited in this regard and any other type of performance measures can be computed, including, but not limited to, any other measure of central tendency or variability of the time delays or any measure of difference of the time delays (or their central tendency and/or their variability), with respect to some reference. The method 400 can then end at step 408 and resume previous processing. For example, method 300 can be resumed.

Referring now to FIG. 5, there is shown a flowchart of steps in an exemplary method 500 for generating performance measures based on a user response to agent responses to user questions. The method 500 begins at step 502 and continues to step 504. At step 504, additional user messages in the online communications channel are identified which consist of a user response to an agent response to a user question. In the various embodiments, a response from a user can be provided in several forms in the online communications channel, depending on the form and type of the online communications channel. Therefore, in some embodiments, the message with the user response can refer explicitly or can be associated with an agent response. For example, in an electronic message board, the response can include the text of the response or can simply be part of the same message thread. In other embodiments, the user response can be a general response. That is, it can be directed to one or more agent responses. Accordingly, the benchmarking system 210 can also be configured to identify responses from a user agent to one or more users based on the type, form, and/or context of the user response with respect to the agent responses in the online communication channel being monitored. The same or similar techniques described above for associating user messages and agent responses can also be used for associating agent responses and user responses.

Once the messages associated with user responses are identified at step 504, these messages can be categorized at step 506. In general, a user response can take several forms and the criteria for categorizing the user responses can vary. For example, in some cases, the criteria can be based on user's perceived level of resolution of the question in a user message. Thus, user responses can be categorized into those in which indicate a resolution of the issue, those indicating only a partial resolution of the issue, and/or those indicating no resolution of the issue. In another example, the messages can be categorized into those posing follow-up questions and those that do not. In yet another example, the messages can be categorized into those expressing satisfaction with the enterprise, its agents, or its products and those that do not. In still another example, the messages can be categorized into those posted by the same user that posted the original question and those posted by other user. Further, any combination of such categorizations can also be used. The content of such user responses can be identified in a substantially similar manner as that described above with respect to user messages associated with user questions or concerns.

After the categorization at step 506, the method 500 can proceed to step 508. At step 508, the total number of user questions leading to user responses in one or more of the categories can be computed and provided as performance measures. That is, for each of the user responses in each category, the original user questions associated with these user responses are identified and tabulated. Once these totals are obtained, the method 500 can end at step 510 and resume previous processing. For example, method 300 can be resumed.

In some embodiments, the performance measure can be generated based on combining information from the various categories. For example, the performance measure can be some measure indicating a number or proportion of positive responses versus negative responses. In another example, the performance measure can be some measure indicating a number or proportion of various levels of resolution of an issue. In yet another example, the performance measure can be some measure indicating a number or proportion of the user responses associated or unassociated with the original user question.

Although the various embodiments are described above with respect to the performance measures or analysis of the performance of a single enterprise with respect to an online communications channel, the various embodiments are not limited in this regard. For, the performance measures and analysis at steps 306 and 308 can be based on messages associated with two or more enterprises associated with the same or similar online communications channels. In another example, the performance measures and analysis at steps 306 and 308 can be based on messages associated with multiple communications channels associated with an enterprise.

Further, although the various embodiments are described above with respect to the performance measures or analysis of the performance of an entire enterprise with respect to one or more online communications channels, the various embodiments are not limited in this regard. That is, in some embodiments, the messages selected for analysis can be those associated with one or more selected portions of an enterprise. For example, the performance of a particular agent or group of agents can be analyzed. In another example, messages can be associated with a particular product, group of products. For example, performance measures and/or analysis can be performed for agents associated with particular products, locations, or interaction types, to name a few.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method for benchmarking customer service performance of an enterprise in online communications channels, the method comprising:
identifying first messages posted by users in an online communications channel during a first time interval, each of the first messages comprising at least one user-identified problem;
identifying second messages posted by agents of the enterprise on the online communications channel, each of the second messages comprising an agent response to at least one of the first messages; and
generating at least one response performance measure for the enterprise based on at least one of a temporal relationship between associated ones of the first messages and the second messages and a user response to content in the second messages.

2. The method of claim 1, wherein the generating of the at least one response performance measure based on the temporal relationship between the first messages and the second messages comprises:
determining a delay for each of the second messages with respect to an associated one of the first messages; and
selecting as the at least one response performance measure an aggregate delay of the second messages.

3. The method of claim 2, wherein the aggregate delay comprises at least one of an average delay, a minimum delay, and a maximum delay.

4. The method of claim 1, wherein the generating of the at least one response performance measure based on the response to the content of the second messages further comprises:
identifying third messages posted by the users on the online communications channel, each of the third messages comprising a user response to at least one of the second messages;
categorizing the third messages into categories; and
computing the response performance measure based at least one of a number and a content of the third messages in at least one of the categories.

5. The method of claim 4, wherein categorizing the third messages further comprises selecting the categories to indicate different levels of resolution of the user-identified problem.

6. The method of claim 4, wherein categorizing the third messages further comprises selecting the categories to indicate one of a positive resolution type and a negative resolution type.

7. The method of claim 4, wherein categorizing the third message further comprises selecting the categories to indicate one of a same user being associated with the user response and a corresponding user-identified problem and a different user being associated with the user response and the corresponding user-identified problem.

8. The method of claim 1, further comprising:
for at least one second time interval, repeating the steps of identifying the first messages, identifying the second messages, and generating the at least one response performance measure; and
generating an aggregate response performance measure for the enterprise based on the at least one response performance measure associated with the first time interval and the at least one second time interval.

9. A system for benchmarking customer service performance of an enterprise provided via an online communications channel, the system comprising:
a processor;
a first module configured to control the processor to access a plurality of messages posted on the online communications channel by users;
a second module configured to control the processor to identify a first portion of the plurality of messages posted during a first time interval and to identify a second portion of the plurality of messages posted by agents of the enterprise, each of the plurality of messages in the first portion identifying at least one user-identified problem, and each of the plurality of messages in the second portion comprising an agent response to the at least one user-identified problem; and
a third module configured to control the processor to generate at least one response performance measure for the enterprise based on a temporal relationship between associated ones of the plurality of messages in the first portion and the second portion.

10. The system of claim 9, where the third module is further configured to control the processor to determine a delay of each of the plurality of messages in the second portion with respect to an associated one of the plurality of messages in the first portion, and select as the response performance measure an aggregate delay for the second portion.

11. The system of claim 10, wherein the aggregate delay comprises at least one of an average delay, a minimum delay, and a maximum delay.

12. The system of claim 9, where the third module is further configured to control the processor to identify a third portion of the plurality of messages posted by the users and comprising user responses to at least one of the plurality of messages in second portion, categorize the third messages into categories, and compute the at least one response performance measure based at least one of a number and a content of the portion of the third plurality of messages in at least one of the categories.

13. The system of claim 12, wherein the plurality of categories indicate different levels of resolution of the issues of the at least one user-identified problem.

14. The system of claim 12, wherein the plurality of categories indicate one of a positive resolution type and a negative resolution type.

15. The system of claim 12, wherein the plurality of categories indicate one of a same user being associated with the user response and the corresponding user-identified problem and a different user being associated with the user response as compared to the corresponding user-identified problem.

16. A non-transitory computer-readable storage medium storing instructions which, when executed by a computing device, cause the computing device to benchmark customer service performance of an enterprise provided via an online communications channel, the instructions comprising:
identifying a first messages posted by users on an online communications channel during a first time interval, each of the first messages comprising at least one user-identified problem;
identifying a second messages posted by agents of the enterprise on the online communications channel, each of the second messages comprising an agent response to at least one of the first messages; and
generating at least one response performance measure for the enterprise based on at least one of a temporal relationship between associated ones of the first messages and the second messages and a user response to a content of the second messages.

17. The non-transitory computer-readable storage medium of claim 16, wherein the instructions for the generating of at least one the response performance measure based on the temporal relationship between the first messages and second messages further comprise:
determining a delay for each of the second messages with respect to an associated one of the first messages; and
selecting as response performance measure an aggregate delay for the second messages.

18. The non-transitory computer-readable storage medium of claim 17, wherein the aggregate delay comprises at least one of an average delay, a minimum delay, and a maximum delay.

19. The non-transitory computer-readable storage medium of claim 16, wherein the instructions for the generating of the at least one response performance measure based on the response to the content of the second messages further comprise:
identifying a third messages posted by the users on the online communications channel, each of the third plurality of messages comprising a user response to at least one of the second messages;
categorizing the third messages into categories; and
computing the at least one response performance measure based at least one of a number and a content of the portion of the third messages in at least one of the categories.

20. The non-transitory computer-readable storage medium of claim 16, the instructions further comprising:
during a second time interval, repeating the steps of identifying the first messages, identifying the second messages, and generating at least one response performance measures; and
generating an aggregate response performance measure for the enterprise based on the response performance measures for the first time interval and the second time interval.
